(19) United States
(12) Patent Application Publication
(10) Pub. No.: US 2025/0110898 A1
(43) Pub. Date: Apr. 3, 2025

(54) Method and Apparatus for Collaborative Memory Accesses

(71) Applicant: Advanced Micro Devices, Inc., Santa Clara, CA (US)

(72) Inventors: Shaizeen Dilawarhusen Aga, Santa Clara, CA (US); Mahzabeen Islam, Dripping Springs, TX (US); Nuwan S. Jayasena, Cupertino, CA (US)

(73) Assignee: Advanced Micro Devices, Inc., Santa Clara, CA (US)

(21) Appl. No.: 18/375,230

(22) Filed: Sep. 29, 2023

(51) Int. Cl. G06F 13/16; G06F 13/42

(52) U.S. Cl. CPC G06F 13/1668; G06F 13/161; G06F 13/4234

(57) ABSTRACT

Method and apparatus for collaborative memory accesses is described. A system includes a memory controller that receives a command from a host. The command is associated with at least one of a plurality of data elements. The memory controller causes execution of data casting operations that adjust a bit size of the plurality of data elements to generate casted data elements. The system includes an interface for communicating data between the host and a memory.

Standard computer architectures typically communicate data back and forth between a memory and a remote processing unit. As a result, in some data intensive applications such as machine learning, conventional computer architectures suffer from increased data transfer latency, require additional energy and computational resource consumption to transfer data from memory, and consume bandwidth during data transfer, which can decrease overall computer performance. In terms of data communication pathways to a memory, remote processing units of conventional computer architectures may be further away from other near-memory processing components. Thus, near-memory processing components enable increased computer performance while reducing data transfer latency, computational resource consumption, and bandwidth consumption in comparison to conventional computer architectures that utilize remote processing hardware to perform certain processing tasks.

### BRIEF DESCRIPTION OF THE DRAWINGS

FIG. 1 is a block diagram of an example system having a host with a core and a memory module with a memory and a processing-in-memory component that implements collaborative memory access logic.

FIG. 2 depicts a block diagram of an example system that enables efficient collaborative memory access by offloading execution of data casting logic to reduce data movement costs.

FIG. 3 depicts a procedure in an example implementation of a memory controller using a processing-in-memory component to support processing collaborative read downcast requests efficiently.

FIG. 4 depicts a procedure in an example implementation of a memory controller using a processing-in-memory component to support processing a collaborative write upcast request efficiently.

FIG. 5 depicts a procedure in an example implementation of processing collaborative read downcast requests using a processing-in-memory component to reduce associated data movement costs.

FIG. 6 depicts a procedure in an example implementation of processing collaborative memory operations efficiently by offloading data casting operations to a memory controller or a processing-in-memory component.

FIG. 7 depicts a procedure in an example implementation of processing collaborative read operations efficiently by performing downcast operations on data prior to transmitting over an interface.

### DETAILED DESCRIPTION

In an effort to increase computational efficiency, some computing device architectures include accelerators that offload compute tasks from a processor device. One such example of an accelerator is a processing-in-memory component. In conventional processing-in-memory system architectures, a host processor coordinates overall system execution and assigns work to processing-in-memory components by broadcasting commands to the processing-in-memory components. Such conventional system architectures are designed to handle regular workloads where all processing-in-memory components execute the same computations on different data. However, these conventional system architectures are not necessarily well suited to handle certain types of high performance computing workloads, such as workloads that involve frequent preprocessing computations.

For example, some machine learning (ML) models and their preprocessing pipelines, require performing upcast or downcast operations on data elements frequently read from and/or written to memory. For instance, a ML application could be programmed to store data elements (e.g., neural network weights) in a 32-bit size floating point format in memory, downcast the data elements to an 8-bit size floating point format prior to using them in a certain computation.

Relying on near-core support for such operations, however, results in high data movement costs. For instance, transporting the data elements in the 32-bit size format from the memory to a core then executing the downcast operations at the core would result in high data bandwidth utilization (four times the bandwidth that would be needed if the downcast operations were instead performed at a near-memory processing location prior to transmitting the data elements to the core). Similarly, upcasting data from the 8-bit size to the 32-bit size prior to transmitting the data back to the memory from the core would also consume a higher data bus bandwidth than if the data was transmitted prior to performing the upcast operations.

Additionally, harnessing conventional processor-in-memory architectures to offload such upcast/downcast computations from the core in an attempt to solve this problem unfortunately requires considerable programmer and/or memory overheads (e.g., task scheduling), and even with such overheads, would not necessarily account for workload requirements (e.g., downcast/upcast operations) as well as relevant hardware limitations (e.g., data bus configuration). For example, offloading an upcast operation on a data element read from memory to a near-memory compute unit instead of performing the upcast operation at the core may result in performance degradation (e.g., higher data bus utilization) instead of a performance improvement. In this example, it would be more efficient to perform the upcast operation after transmitting it over the data bus. As another example, if a data bus configuration has a bandwidth (e.g., data burst size, etc.) that is greater than a bit size of a downcast data element, a conventional system might schedule transmitting the downcast data element with dummy data to fill a data burst and/or the conventional system might experience inconsistent scheduling latency issues while it waits for additional data to combine with the downcast data element (depending on the system's scheduling algorithm).

To address these conventional problems, methods and systems for collaborative memory access are described. In one or more implementations, a system includes collaborative memory access logic that enables dynamically handling data casting operation execution either near-core (or memory controller) or near-memory to achieve improved data bus utilization and/or computing performance enhancements. Advantageously, the collective memory access logic is programmable in an application-specific manner, such that an application developer and/or a compiler is able to indicate when execution of a command should trigger execution of additional processing-in-memory operations (e.g., downcast, upcast, etc.) to best suit the needs of the application without significant programmer overhead, by transparently managing data movement overheads efficiently.

In accordance with one or more implementations, an example system includes a memory controller that is configured to receive a command from a host. In an example, the command is associated with a data casting request and/or a collaborative memory operation that involves a plurality of data elements. For instance, the command may be a collaborative memory read operation called using a function that implies a downcast operation is requested (e.g., read_downcast_32b_8b could indicate a request for a downcast degree of 4). In this example, the memory controller forwards the command to a near-memory compute unit (e.g., a processing-in-memory component of a memory module, etc.), and keeps track of a number of collaborative requests forwarded to the processing-in-memory component. The processing-in-memory component then executes a downcast operation on a data element included in the command and stores the result (e.g., downcast data element having a bit size of 8 bits) in a local register. The processing-in-memory component may also receive additional commands with other related data elements and store a corresponding plurality of downcast data elements in the local register. In this example, once a threshold number of downcast data elements is stored in the local register (e.g., when the local register is full), the processing-in-memory component transmits a single data response message, over a data bus and via the memory controller, back to the host. The data response message, for example, includes the plurality of downcast data elements (e.g., four elements). Thus, in this example, the example system reduces data bus utilization by sending a single data response message for four collaborative read commands instead of sending four data response messages.

Although techniques are described herein with respect to a single accelerator (e.g., an accelerator configured as a processing-in-memory component), the described techniques are configured for implementation by multiple accelerators in parallel (e.g., simultaneously). For instance, in an example scenario where memory is configured as dynamic random-access memory (DRAM), a processing-in-memory component is included at each hierarchical DRAM component (e.g., channel, bank, array, and so forth). In additional or alternative implementations, the techniques described herein include performing some of the functions described for the processing-in-memory component in the examples above at the memory controller. For instance, one or more upcast/downcast operations are executed at the memory controller prior to transmission to the memory module.

The techniques described herein thus enable a host processor to cause execution of upcast or downcast operations by a memory controller or a near-memory processing component instead of performing them at the host processor to reduce data movement overhead associated with transmitting large bit size data that will eventually be downcast or upcasting data to a large bit size prior to transmission when it could instead be upcast at a later point along the data pipeline. Advantageously, selectively triggering execution of data casting operations at a downstream processing component (e.g., near-memory or at memory controller) or at a near-core processor can improve data bus utilization efficiently. The described techniques further advantageously save cycles of the remote host processor and/or improves memory controller scheduling latency by delaying and/or combining transmission of casted data elements associated with a collaborative memory operation.

In some aspects, the techniques described herein relate to a system including: a memory controller configured to: receive a command from a host, the command associated with at least one of a plurality of data elements, and cause execution of data casting operations that adjust a bit size of the plurality of data elements to generate casted data elements, and an interface for communicating data between the host and a memory.

In some aspects, the techniques described herein relate to a system, wherein the interface is configured to transmit the casted data elements.

In some aspects, the techniques described herein relate to a system, wherein the memory controller is configured to execute the data casting operations.

In some aspects, the techniques described herein relate to a system, wherein the memory controller is configured to cause a processing-in-memory component of the memory to execute the data casting operations by transmitting a plurality of commands to the processing-in-memory component.

In some aspects, the techniques described herein relate to a system, further including: the processing-in-memory component, wherein the processing-in-memory component is configured to: receive the plurality of commands, each of the plurality of commands corresponding to at least one data element of the plurality of data elements; perform a downcast operation that reduces a bit size of the at least one data element to generate at least one downcast data element; and transmit, over the interface, a data response including a plurality of downcast data elements as the casted data elements.

In some aspects, the techniques described herein relate to a system, wherein the processing-in-memory component is further configured to: store, at a register, the at least one downcast data element; and trigger transmission of the data response.

In some aspects, the techniques described herein relate to a system, wherein the memory controller is further configured to trigger transmission of the data response.

In some aspects, the techniques described herein relate to a system, further comprising a processing-in-memory component, wherein the memory controller is configured to cause the processing-in-memory component of the memory to execute the data casting operations by transmitting the command to the processing-in-memory component, wherein the processing-in-memory component is configured to: retrieve the plurality of data elements from the command; and perform, for each of the plurality of data elements, an upcast operation to generate a plurality of upcast data elements as the casted data elements.

In some aspects, the techniques described herein relate to a system, wherein the memory controller is further configured to: retrieve the plurality of data elements from the command; and perform, for each of the plurality of data elements, an upcast operation to generate a plurality of upcast data elements as the casted data elements.

In some aspects, the techniques described herein relate to a method including: receiving a command from a host, the command associated with at least one of a plurality of data elements; and executing data casting operations that adjust a bit size of the plurality of data elements to generate casted data elements.

In some aspects, the techniques described herein relate to a method, further comprising transmitting the casted data elements over an interface between the host and a memory.

In some aspects, the techniques described herein relate to a method, wherein executing the data casting operations is by a memory controller.

In some aspects, the techniques described herein relate to a method, wherein executing the data casting operations is by a processing-in-memory component.

In some aspects, the techniques described herein relate to a method, further including: for each data element of the plurality of data elements, performing a downcast operation that reduces a bit size of the data element to generate a downcast data element; and transmitting, over an interface, a data response including a plurality of downcast data elements as the casted data elements.

In some aspects, the techniques described herein relate to a method, further including: retrieving the plurality of data elements from the command; and performing, for each of the plurality of data elements, an upcast operation to generate a plurality of upcast data elements as the casted data elements.

In some aspects, the techniques described herein relate to a method including: receiving a plurality of commands indicating a plurality of data elements; executing a downcast operation that reduces a bit size of the plurality of data elements to generate a plurality of downcast data elements; and transmitting a data response over an interface, the data response including the plurality of downcast data elements.

In some aspects, the techniques described herein relate to a method, wherein executing the downcast operation is at a processing-in-memory component.

In some aspects, the techniques described herein relate to a method, further including: storing, at a register, the respective downcast data element.

In some aspects, the techniques described herein relate to a method, further including: receiving an additional command including an additional plurality of data elements.

In some aspects, the techniques described herein relate to a method, further including: performing, for each of the additional plurality of data elements, an upcast operation to generate a plurality of upcast data elements.

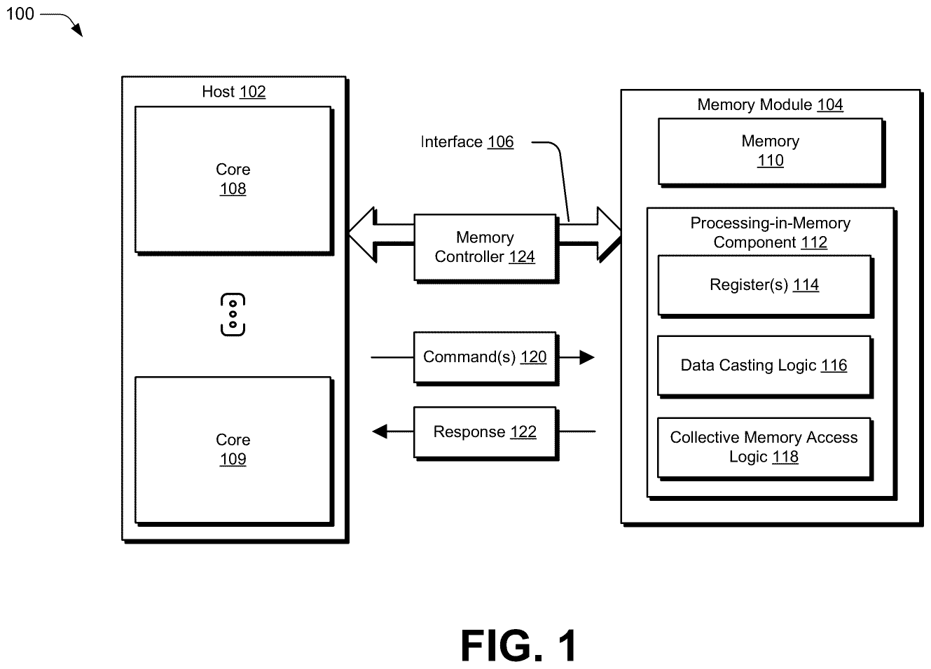

FIG. 1 is a block diagram of an example system 100 having a host with a core and a memory module with a memory and a processing-in-memory component that implements collaborative memory access logic. In particular, the system 100 includes host 102 and memory module 104, where the host 102 and the memory module 104 are communicatively coupled via interface 106. In one or more implementations, the host 102 includes at least one core. In some implementations, the host 102 includes multiple cores. For instance, in the illustrated example of FIG. 1, host 102 is depicted as including core 108 and core 109. In alternate embodiments, system 100 includes fewer or more cores. The memory module 104 includes memory 110 and processing-in-memory component 112.

In accordance with the described techniques, the host 102 and the memory module 104 are coupled to one another via a wired or wireless connection, which is depicted in the illustrated example of FIG. 1 as the interface 106. Example wired connections include, but are not limited to, buses (e.g., a data bus), interconnects, traces, and planes. Examples of devices in which the system 100 is implemented include, but are not limited to, supercomputers and/or computer clusters of high-performance computing (HPC) environments, servers, data center servers, personal computers, laptops, desktops, game consoles, set top boxes, tablets, smartphones, mobile devices, virtual and/or augmented reality devices, wearables, medical devices, systems on chips, and other computing devices or systems.

The host 102 is an electronic circuit that performs various operations on and/or using data in the memory 110. Examples of the host 102 and/or the core 108 include, but are not limited to, a central processing unit (CPU), a graphics processing unit (GPU), a field programmable gate array (FPGA), an accelerated processing unit (APU), and a digital signal processor (DSP). For example, the core 108 is a processing unit that reads and executes instructions (e.g., of a program), examples of which include to add, to subtract, to move data, to branch, and so forth.

In one or more implementations, the memory module 104 is a circuit board (e.g., a printed circuit board), on which the memory 110 is mounted and includes the processing-in-memory component 112. In some variations, one or more integrated circuits of the memory 110 are mounted on the circuit board of the memory module 104, and the memory module 104 includes one or more processing-in-memory components 112. Examples of the memory module 104 include, but are not limited to, a TransFlash memory module, a single in-line memory module (SIMM), and a dual in-line memory module (DIMM). In one or more implementations, the memory module 104 is a single integrated circuit device that incorporates the memory 110 and the processing-in-memory component 112 on a single chip. In some examples, the memory module 104 is composed of multiple chips that implement the memory 110 and the processing-in-memory component 112 that are vertically (“3D”) stacked together, are placed side-by-side on an interposer or substrate, or are assembled via a combination of vertical stacking or side-by-side placement.

The memory 110 is a device or system that is used to store information, such as for immediate use in a device (e.g., by the core 108 of the host 102 and/or by the processing-in-memory component 112). In one or more implementations, the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), and static random-access memory (SRAM).

In some implementations, the memory 110 corresponds to or includes a cache memory of the core 108 and/or the host 102 such as a level 1 cache, a level 2 cache, a level 3 cache, and so forth. Alternatively or additionally, the memory 110 corresponds to or includes a near-memory cache (e.g., a local cache for the processing-in-memory component 112). Alternatively or additionally, the memory 110 represents high bandwidth memory (HBM) in a 3D-stacked implementation. Alternatively or additionally, the memory 110 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). The memory 110 is thus configurable in a variety of ways that support performance of operations using data stored in memory (e.g., of the memory 110), using processing-in-memory, without departing from the spirit or scope of the described techniques.

The processing-in-memory component 112 is an example of an accelerator or other near-memory compute unit utilized by the host 102 to offload performance of computations (e.g., computations that would otherwise be performed by the core 108 in a conventional computing device architecture). Although described with respect to implementation by the processing-in-memory component 112, the techniques described herein are configured for implementation by a variety of different accelerator configurations (e.g., a near-memory compute unit, an arithmetic logic unit (ALU), or an accelerator other than a processing-in-memory component). Generally, the processing-in-memory component 112 is configured to process processing-in-memory instructions (e.g., received from the core 108 via the interface 106). The processing-in-memory component 112 is representative of a processor with example processing capabilities ranging from relatively simple (e.g., an adding machine) to relatively complex (e.g., a CPU/GPU compute core). In an example, the processing-in-memory component 112 includes hardware (e.g., circuitry) physically located at or near the memory 110 and wired to perform logic functions (e.g., data casting logic 116, collective memory access logic 118) and/or to execute program instructions. In an example, the processing-in-memory component 112 processes instructions using data stored in the memory 110.

Processing-in-memory contrasts with standard computer architectures which obtain data from memory, communicate the data to a remote processing unit (e.g., the core 108 of the host 102), and process the data using the remote processing unit (e.g., using the core 108 of the host 102 rather than the processing-in-memory component 112). In various scenarios, the data produced by the remote processing unit as a result of processing the obtained data is written back to memory, which involves communicating the produced data over the interface 106 from the remote processing unit to memory. In terms of data communication pathways, the remote processing unit (e.g., the core 108 of the host 102) is further away from the memory 110 than the processing-in-memory component 112, both physically and topologically. As a result, conventional computer architectures suffer from increased data transfer latency, reduced data communication bandwidth, and increased data communication energy, particularly when the volume of data transferred between the memory and the remote processing unit is large, which can also decrease overall computer performance.

Thus, the processing-in-memory component 112 enables increased computer performance while reducing data transfer energy as compared to standard computer architectures that implement remote processing hardware. Further, the processing-in-memory component 112 alleviates memory performance and energy bottlenecks by moving one or more memory-intensive computations closer to the memory 110. Although the processing-in-memory component 112 is illustrated as being disposed within the memory module 104, in some examples, the described benefits of triggering processing-in-memory commands are extendable to near-memory processing implementations in which an accelerator (e.g., the processing-in-memory component 112) is disposed in closer proximity to the memory 110 (e.g., in terms of data communication pathways) than the core 108 of the host 102.

The processing-in-memory component 112 is depicted as including one or more registers 114. Each of the one or more registers 114 is representative of a data storage location in the processing-in-memory component 112 that is configured to store data (e.g., one or more bits of data). Although described herein in the example context of registers, the one or more registers 114 are representative of any suitable configuration of one or more data storage components, such as a cache, a scratchpad memory, a local store, or other type of data storage component configured to store data produced by the accelerator locally (e.g., independent of transmitting data produced by the accelerator to memory of the memory module). Each of the one or more registers 114 is associated with an address that defines where data stored by the respective register is located within the processing-in-memory component 112.

By virtue of an associated address, each of the one or more registers 114 are uniquely identifiable (i.e., distinguishable from other ones of the one or more registers 114). For instance, in some implementations each of the one or more registers 114 has an identifier assigned to the register that uniquely identifies the register relative to others of the one or more registers 114. In an example where the one or more registers 114 include N different registers, the system 100 uses log₂(N) bits to uniquely identify the registers 114. In other implementations, an accelerator utilizes a local cache to store data and address information, which uniquely identifies different locations within the cache (e.g., the one or more registers 114 are representative of different locations within a local cache for an accelerator, where the different locations are addressed by block identifiers).

In some implementations, the one or more registers 114 are representative of a scalar register, which is configured to store a single value for one or more lanes, such that different lanes store data describing a common numerical value. Alternatively or additionally, the one or more registers 114 are representative of a register configured to store multiple different values (e.g., a general purpose register). In implementations where the one or more registers 114 include a register configured to store multiple different values, different lanes of the register are capable of storing different numerical values, contrasting with the single value storage capabilities of a scalar register.

The processing-in-memory component 112 is further depicted as including a data casting logic 116 and a collective memory access logic 118. The data casting logic 116 is representative of functionality of the processing-in-memory component 112 that causes the processing-in-memory component 112 to locally perform data casting operations (e.g., upcast, downcast, etc.) based on a command received from the host 102. The collective memory access logic 118 is representative of functionality of the processing-in-memory component 112 that causes the processing-in-memory component 112 to locally perform operations that facilitate collective memory operations. One example data casting operation is an upcast operation, in which the processing-in-memory component 112 upcasts a data element from a first format (e.g., 8 bit floating point) having a first bit size to a second format (e.g., 32 bit floating point) having a second bit size.

In an example, during runtime of an application, the host 102 transmits the command 120 over the interface 106 for execution by one or more processing-in-memory components. For example, in a scenario where a command 120 is a request for a memory read operation as well as a downcast operation on a data element (read from memory 110 by executing the memory read operation), the data casting logic 116 causes the processing-in-memory component 112 to downcast the data element from a first format (e.g., 32 bit floating point) that has a first bit size to a second format (e.g., 8 bit floating point) that has a second bit size. Further, in this example, the collective memory access logic 118 causes the processing-in-memory component 112 to store the downcast data element into the register 114. Further, in this example, when additional related collaborative memory access commands are received and executed by the processing-in-memory component 112, additional downcast data elements are similarly computed and stored in the register 114. In an example, once a threshold number of downcast elements are stored in the register 114, the collective memory access logic 118 then causes the processing-in-memory component 112 to generate and transmit a single data response message (e.g., response 122) that includes the multiple downcast data elements stored in the register 114 over the interface 106 back to the host 102.

Advantageously, the data casting logic 116 enables the host 102 to concurrently execute other operations (e.g., operations of a compute-intensive workload) while the processing-in-memory component 112 is locally executing commands (e.g., commands that involve operations of a data-intensive workload). Because additional commands are triggered locally at the processing-in-memory component 112, triggering and executing the additional commands does not create traffic on the interface 106, which frees bandwidth for the host 102 to retrieve data from, and write data to, memory 110 involved with executing operations locally at the host 102.

It is noted that in some embodiments, one or more of the functions described above for the processing-in-memory component 112 are additionally or alternatively performed by the memory controller 124. For example, in a scenario where a command 120 is received indicating a request for a memory write operation together with an upcast operation, the memory controller 124 is optionally configured to perform an upcast operation on the data elements in the command before transmitting memory write instructions for the upcast data elements to the memory module 104 over the interface 106.

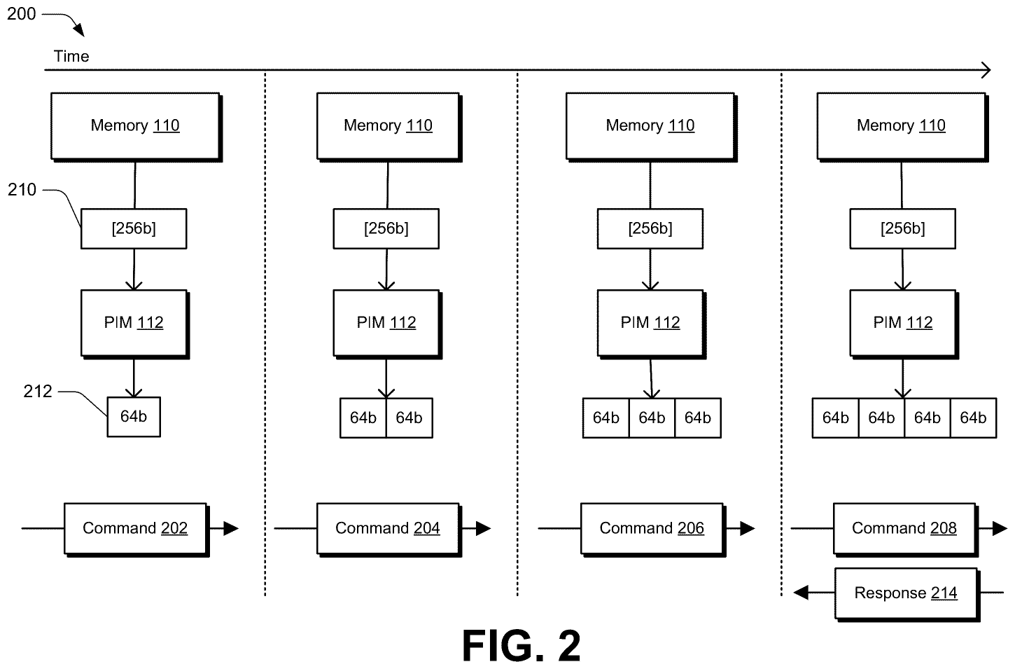

FIG. 2 depicts a block diagram of an example system 200 that enables efficient collaborative memory access by offloading execution of data casting logic to reduce data movement costs. In particular, FIG. 2 illustrates a scenario where the system 200 receives multiple related memory read commands 202, 204, 206, 208 with downcast instructions over time.

In an example, the system 200 receives a command 202 (similar to command(s) 120) indicative of a request for a collaborative memory read with downcast. In an example, the command 202 includes a memory address of a first data element of a plurality of data elements associated with the collaborative memory operation. In the example, the processing-in-memory component 112 retrieves the first data element, which has a bit size of 256 bits, from the memory address indicated in the command 202. The processing-in-memory component 112 then executes a downcast operation locally to convert a format of the data element 210 from a 256 bit size to a 64 bit size as the downcast data element 212. In an example, the processing-in-memory component 112 then stores the downcast data element 212 (e.g., in register 114), but does not send back a data response with the downcast data element 212 yet. Next, the system 200 similarly receives command 204, 206, and 208, and similarly performs a memory read operation followed by a downcast operation and stores the downcast data element (64-bit size) into the register 114. In an example, once a certain number of data elements is read and stored in the register (e.g., four downcast data elements) or in response to another threshold condition, the processing-in-memory component 112 then generates and transmits a single data response 214 including all the stored downcast data elements. In alternative embodiments, another processing component upstream of the host 102 performs one or more of the functions described above for the processing-in-memory component 112 and/or the register 114 (e.g., a dedicated data register in the memory controller 124, etc.).

In yet another example, the system 200 is configured to perform a collaborative memory write operation by performing upcast operations upstream of the host 102 (e.g., at the processing-in-memory component 112 and/or the memory controller 124) prior to writing the upcast data elements into the memory 110. Advantageously, performing downcast operations (for memory reads) and/or upcast operations (for memory writes) upstream of the host 102 with respect to the interface 106 (e.g., at the memory controller 124 and/or the processing-in-memory component 112) and temporarily storing the upcast or downcast results on a nearby register or other local storage enables the system 200 to reduce data bandwidth overhead across the interface 106 by avoiding unnecessary data movement (e.g., by transmitting smaller bit size data elements over the interface 106), while also enabling reduced programmer overhead and/or memory controller complexity.

In yet another example, the command 202 includes a collaborative memory read command with downcast from multiple memory banks. For instance, in a 32 bit to 8 bit downcast read request scenario, the command 202 corresponds to a memory read of 256 bits that includes eight 32-bit words stored in four or eight memory banks. Thus, a single multibank collaborative read command involves the system 200 reading multiple data elements from multiple banks of memory 110 and downcasting the multiple read elements from into a 64 bit size word that corresponds to a combination of multiple downcast data elements.

In some examples, the system 200 is configured to manage storage space in the register 114 instead of or in addition to triggering transmission of the response 214 when the register 114 is full. Advantageously, management of the storage space in register 114 may avoid starvation or deadlock issues. In an example, the memory controller 124 tracks available register space in register(s) 114 and modulate collaborative read request issue rate strategically to avoid starvation or deadlock. In another example, the memory controller 124 is configured to enforce a read return (i.e., trigger transmission of the data response 214) even if the register 114 is not full. For instance, the memory controller 124 and/or the processing-in-memory component 112 is configured to trigger transmission of the response 214 in response to a determination that a threshold amount of time passed since a collaborative read response was last issued.

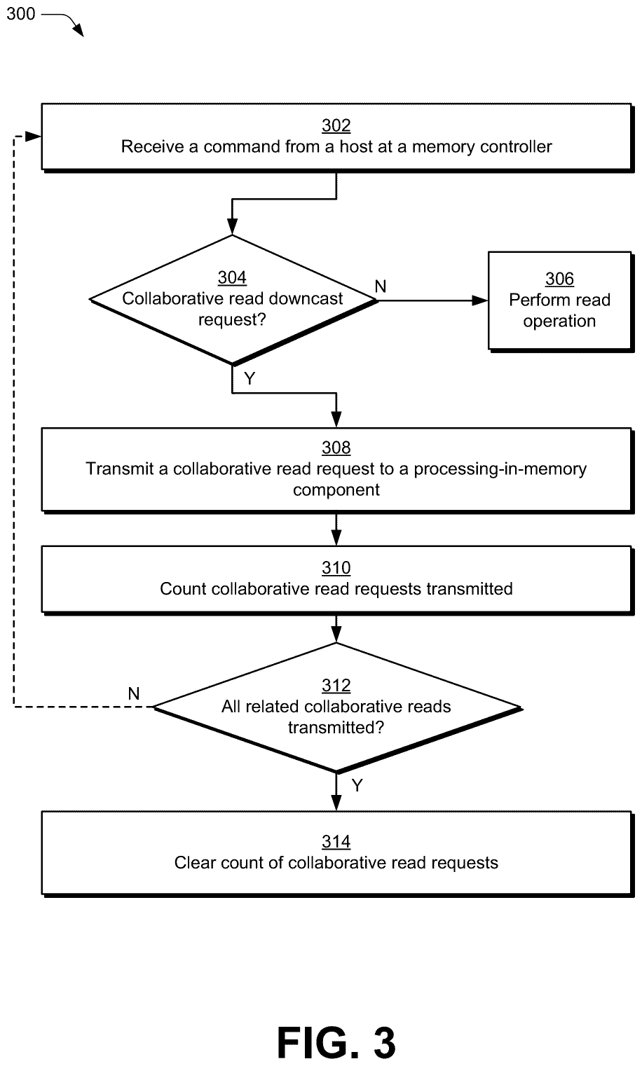

FIG. 3 depicts a procedure 300 in an example implementation of a memory controller using a processing-in-memory component to support processing collaborative read downcast requests efficiently.

First, a memory controller 124 receives a command (e.g., command 202) from a host 102 (block 302). The memory controller 124 then checks if the received command is a collaborative read downcast request (block 304). In an example, the degree of downcast and/or upcast of a given command is implied in the instruction used to submit the command (e.g., at the host 102). For instance, a calling function “read_downcast_32b_8b( )” implicitly implies a request for a collaborative read with downcast having a degree of four (e.g., 32/8=4). In some examples, the memory controller 124 and/or the memory module 104 is configured to determine common address bits for collaborative accesses based on the received command.

In an example, a programmer tags the command or otherwise identifies it as a requiring downcast or upcast. In this example, the programmer also provides other relevant attributes in the command (e.g., address, etc. for reads, or address and data element(s) for writes). In another example, the host 102 is configured to issue a wide request, i.e., the request represents a contiguous range of addresses which are collaborative with each other (e.g., an address range for a collaborative memory read operation). For instance, where the command is for a downcast of degree four, the command includes the addresses of four data elements.

If the received command is a memory read request but not a collaborative read with downcast request, the memory controller 124 then causes the memory module 104 to perform a regular memory read operation and return a response, e.g., execute memory read operation to retrieve one data element and return a data response with that one data element (block 306). Otherwise, if the received command is determined to be a collaborative read with downcast request, the memory controller 124 transmits (e.g., over interface 106) the command indicating the collaborative read request to the memory module 104 (block 308). The memory controller 124 tracks or counts how many commands or requests are collaborating with each other, e.g., how many related commands 202, 204, 206, 208 have been forwarded to the processing-in-memory component 112 so far (block 310). If there are still one or more remaining collaborative commands, the process 300 returns to block 302 and waits to receive additional commands (block 312). Otherwise, once all the related commands 202, 204, 206, 208, etc. have been transmitted to the memory module 104 and/or upon otherwise receiving (from the memory module 104) a response for a group of commands and/or requests collaborating with each other, the memory controller 124 determines that pending read request for this group is complete, e.g., by clearing the count of collaborative read requests with downcast transmitted so far (block 314).

In alternative or additional examples, the host 102 and/or the processing-in-memory component 112 can perform one or more of the functions described above for the memory controller 124. For example, a core 108(1)-108(n) and/or the processing-in-memory component 112 is configured to keep track or count the number of related memory read requests collaborating with one another that have been processed so far instead of or in addition to the memory controller 124. In some examples, to save tracking costs, the memory controller 124 is configured to keep track of one collaborative read request and its associated counter at a time. Thus, for instance, the memory controller 124 clears the counter before starting a new count for a new group of collaborative memory read and/or memory write operations. In alternative or additional examples, where a wide read request with downcast command is supported (e.g., where the command from the host 102 includes multiple addresses or an address range), the memory controller 124 is configured to unroll the combined command into multiple (e.g., four) separate memory read requests transmitted to the memory module 104 (e.g., one memory read request for each of four addresses indicated in the command from the host 102).

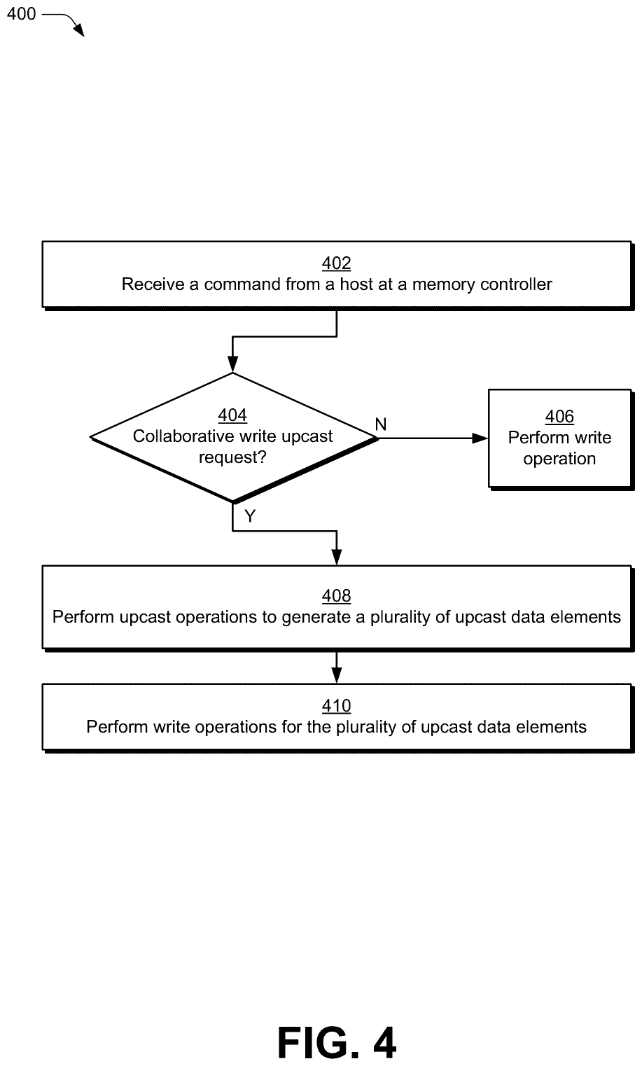

FIG. 4 depicts a procedure 400 in an example implementation of a memory controller using a processing-in-memory component to support processing a collaborative write upcast request efficiently.

In the procedure 400, the memory controller 124 first receives a command 120 from the host 102 (block 402). The memory controller 124 then determines if the received command is a request for a collaborative write with upcast (block 404). For example, a programmer implicitly implies the type of command by using a particular calling function, and/or the command includes a tag or other indication of the operations (e.g., memory write and upcast) requested by the host 102 in the command.

If the memory controller 124 determines that the command is not a request for a collaborative write with upcast (block 406) but that the command requests a regular memory write operation only, then the memory controller 124 causes the memory module 104 to perform a regular memory write operation, e.g., by forwarding the command to the memory module 104. For instance, where the command is a regular memory write request, the command includes an address and/or the data element that is to be written into the memory 110. Otherwise, where the received command is for a collaborative memory write with upcast, the memory controller 124 performs one or more upcast operations on the data element(s) in the command to generate a plurality of upcast data elements (block 408). In examples, the memory controller 124 then transmits, e.g., over interface 106, the multiple write operations and causes the memory module 104 to perform the memory write operations for the plurality of upcast data elements (block 410).

For instance, where the command includes four data elements (8 bits each) and the upcast degree is four, the memory controller 124 casts the four data elements into four upcast data elements with a bit size of 32 bit for each upcast data element. In some examples, performing the upcast operations at the memory controller 124 may reduce or mitigate latency and/or scheduling issues associated with performing the upcast computations and issuing multiple write operations at the processing-in-memory component 112. However, in alternate examples, the processing-in-memory component 112 and/or other near-memory logic is configured to perform the upcast operations and the memory controller 124 forwards the command received from the host without performing the upcast operations locally.

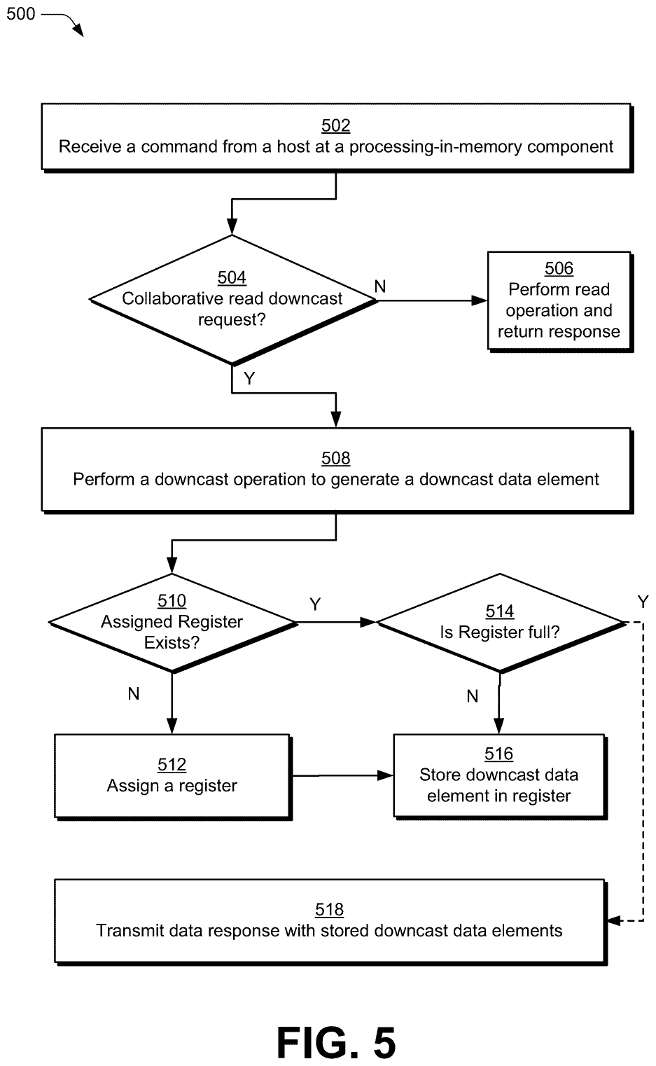

FIG. 5 depicts a procedure 500 in an example implementation of processing collaborative read downcast requests using a processing-in-memory component to reduce associated data movement costs.

The processing-in-memory component 112 or other near-memory processing device receives a command 202 from host 102 via memory controller 124 (block 502). The processing-in-memory component 112 determines whether the received command corresponds to a request for a collaborative memory read operation with downcast (block 504). For instance, an indication of the type of request, etc., is implicitly implied by the calling function, included as a tag or other indication in the command, and/or by the attributes or other parameters included in the command (e.g., range of addresses, etc.). If the processing-in-memory component 112 determines that the command is for a normal memory read operation that does not include a request for a downcast operation (block 506), then the processing-in-memory component performs a regular memory read operation to read a single data element and return a data response (over the interface 106) for the command. Otherwise, the processing-in-memory component 112 is configured to perform a memory read and a downcast operation on the read data element (block 508).

The processing-in-memory component 112 also determines whether a register address is assigned for the collaborative read command (block 510). For example, the processing-in-memory component 112 is configured to assign a first address in register 114 for temporarily storing a first group of related collaborative memory requests. Thus, in this example, each downcast data element for the group is stored in the register 114 at the first address after shifting previously stored downcast data elements. On the received command is for a different second group of collaborative read requests (i.e., no address previously assigned), then the processing-in-memory component 112 is configured to assign a new address in the register 114 for storing the downcast data element associated with the command (block 512).

In some examples, instead of or in addition to assigning an exact address for each group of related read with downcast requests, the processing-in-memory component 112 is configured to select a new register address or select a register address that is suitable for the properties of the current read command. For example, if a register address includes data elements that were downcast to a same degree (e.g., degree of four), the processing-in-memory component is configured to select that address for the current read command even if it is not part of the same group of related collaborative read requests. In an example, a certain downcast degree is selected by a user (e.g., programmed or default value) such as a downcast degree of four, etc., and the processing-in-memory component is configured to use that preselected or default value to select or assign a register for storing the downcast data element.

The processing-in-memory component 112 then determines whether the register (at least at the selected and/or assigned address for the current read request), is full (block 514). If the register is not full (and/or if a new register address was assigned), then the processing-in-memory component 112 shifts the register and/or stores the downcast data element (e.g., data element 212) into the register 114 (block 516). If the register and/or register address is full, then the processing-in-memory component 112 generates a data response with all the stored downcast data elements from the register 114 and transmits the data response (e.g., 214) response over the interface 106 to the memory controller 124 and/or the host 102 (block 518).

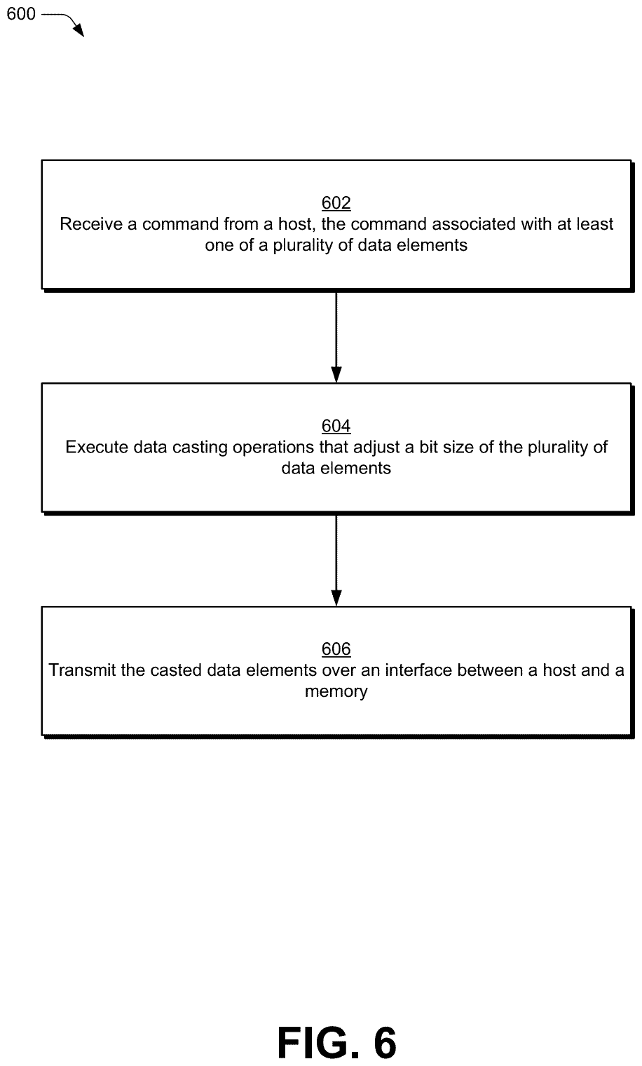

FIG. 6 depicts a procedure 600 in an example implementation of processing collaborative memory operations efficiently by offloading data casting operations to a memory controller or a processing-in-memory component.

In the procedure 600, the memory controller 124, the processing-in-memory component 112, and/or other near-memory processing device receives a command from the host 102 (block 602). The command is associated with at least one of a plurality of data elements. As an example, the command 120 includes a request for a memory read operation with downcast or a request for a memory write operation with upcast. For instance, the command 120 includes a tag or other indication that it is associated with a collaborative memory operation that requires data casting, one or more memory addresses, and/or one or more data elements that are to be read or written to memory 110.

The memory controller 124 and/or the processing-in-memory component 112 perform data casting operations that adjust a bit size of the plurality of data elements (block 604). For instance, where the plurality of data elements or their memory addresses are indicated in the received command, the processing-in-memory component 112, the memory controller 124, or other near-memory processing device is configured to perform upcast or downcast operations locally to change a data format of the plurality of data elements, e.g., by upcasting or downcasting each data element, to a different data format associated with a different bit size (e.g., from 32 bits to 8 bits, etc.). In some examples, the memory controller 124 and/or the processing-in-memory component 112 performs a single data casting operation for the received command and additional data casting operations when other collaborative or otherwise related commands are received. Thus, in an example, an upcast operation is a data casting operation that adjusts (increases) a bit size of one or more data elements. Further, in an example, a downcast operation is a data casting operation that adjusts (decreases) a bit size of one or more data elements. For instance, with reference to FIG. 2, data element 210 having a bit size of 256 bytes can be processed by PIM 112 executing a downcast operation to adjust (decrease) its bit size to 64 bits, as illustrated by data element 212. This downcast operation, for instance, is performed at PIM 112 prior to transmitting response 214 to reduce the bandwidth required to transmit the data element to a host (e.g., host 102) as part of a memory read operation. Similarly, an upcast operation can be performed at the PIM 112 to convert a data element transmitted to the memory module 104 with a small bit size (to reduce bandwidth requirement) into a larger bit size before storing it in the memory 110.

The memory controller 124 and/or the processing-in-memory component 112 then transmits the casted data elements (block 606). For example, where the casted data elements are upcast data elements to be written to the memory 110, the processing-in-memory component 112 and/or the memory controller 124 perform or cause execution of multiple memory write commands corresponding to a plurality of upcast data elements so as to store the upcast data elements into the memory 110 at specific memory addresses. As another example, where the casted data elements are downcast data elements. The processing-in-memory component 112 and/or the memory controller 124 transmit the downcast data elements in a single data response to the host 102.

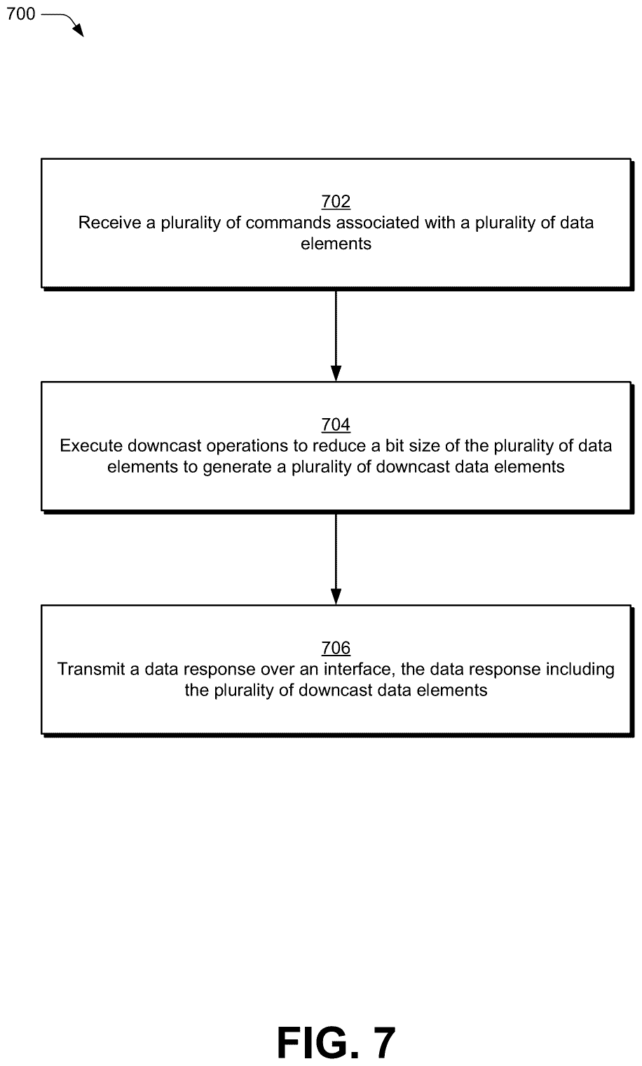

FIG. 7 depicts a procedure 700 in an example implementation of processing collaborative read operations efficiently by performing downcast operations on data prior to transmitting over an interface.

In the procedure 700, the memory controller 124, the processing-in-memory component 112, and/or other near-memory processing device receives a plurality of commands 202, 204, 206, 208 (block 702). Each of the plurality of commands 202, 204, 206, 208 includes an indication, such as a memory address, of at least one data element (e.g., data element 210) of a plurality of data elements. In an example, the plurality of data elements are identified by the host 102 or otherwise selected as a group of data elements that should be read and returned back to the host 102 in a single response message.

The processing-in-memory component 112 and/or the memory controller 124 executes downcast operations (block 704) that reduce a bit size of the plurality of data elements to generate a plurality of downcast data elements (e.g., data element 212). In an example, the processing-in-memory component 112 performs a memory read operation and a downcast operation for each data element of the plurality of elements. The processing-in-memory component 112 and/or the memory controller 124 then transmit a data response 214 over an interface 106 to the host 102 (block 706). The data response 214 includes the plurality of downcast data elements, i.e., combined together in a single message or response to the host 102 for all the commands 202, 204, 206, 208.

The example techniques described herein are merely illustrative and many variations are possible based on this disclosure. Although features and elements are described above in particular combinations, each feature or element is usable alone without the other features and elements or in various combinations with or without other features and elements.

The various functional units illustrated in the figures and/or described herein (including, where appropriate, the host 102 having the core 108, the memory controller 124, the memory module 104 having the memory 110 and the processing-in-memory component 112, and the registers 114 and the data casting logic 116 of the processing-in-memory component 112) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a memory controller configured to:
receive a command from a host, the command associated with at least one of a plurality of data elements, and
cause execution of data casting operations that adjust a bit size of the plurality of data elements to generate casted data elements; and
an interface for communicating data between the host and a memory.

2. The system of claim 1, wherein the interface is configured to transmit the casted data elements.

3. The system of claim 1, wherein the memory controller is configured to execute the data casting operations.

4. The system of claim 1, wherein the memory controller is configured to cause a processing-in-memory component of the memory to execute the data casting operations by transmitting a plurality of commands to the processing-in-memory component.

5. The system of claim 4, further comprising:
the processing-in-memory component, wherein the processing-in-memory component is configured to:
receive the plurality of commands, each of the plurality of commands corresponding to at least one data element of the plurality of data elements;
perform a downcast operation that reduces a bit size of the at least one data element to generate at least one downcast data element; and
transmit, over the interface, a data response including a plurality of downcast data elements as the casted data elements.

6. The system of claim 5, wherein the processing-in-memory component is further configured to:
store, at a register, the at least one downcast data element; and
trigger transmission of the data response.

7. The system of claim 5, wherein the memory controller is further configured to trigger transmission of the data response.

8. The system of claim 1, further comprising:
a processing-in-memory component, wherein the memory controller is configured to cause the processing-in-memory component of the memory to execute the data casting operations by transmitting the command to the processing-in-memory component, wherein the processing-in-memory component is configured to:
retrieve the plurality of data elements from the command; and
perform, for each of the plurality of data elements, an upcast operation to generate a plurality of upcast data elements as the casted data elements.

9. The system of claim 1, wherein the memory controller is further configured to:
retrieve the plurality of data elements from the command; and
perform, for each of the plurality of data elements, an upcast operation to generate a plurality of upcast data elements as the casted data elements.

10. A method comprising:
receiving a command from a host, the command associated with at least one of a plurality of data elements; and
executing data casting operations that adjust a bit size of the plurality of data elements to generate casted data elements.

11. The method of claim 10, further comprising:
transmitting the casted data elements over an interface between the host and a memory.

12. The method of claim 10, wherein executing the data casting operations is by a memory controller.

13. The method of claim 10, wherein executing the data casting operations is by a processing-in-memory component.

14. The method of claim 10, further comprising:
for each data element of the plurality of data elements, performing a downcast operation that reduces a bit size of the data element to generate a downcast data element; and
transmitting, over an interface, a data response including a plurality of downcast data elements as the casted data elements.

15. The method of claim 10, further comprising:
retrieving the plurality of data elements from the command; and
performing, for each of the plurality of data elements, an upcast operation to generate a plurality of upcast data elements as the casted data elements.

16. A method comprising:
receiving a plurality of commands indicating a plurality of data elements;
executing a downcast operation that reduces a bit size of the plurality of data elements to generate a plurality of downcast data elements; and
transmitting a data response over an interface, the data response including the plurality of downcast data elements.

17. The method of claim 16, wherein executing the downcast operation is at a processing-in-memory component.

18. The method of claim 16, further comprising:
storing, at a register, the respective downcast data element.

19. The method of claim 16, further comprising:
receiving an additional command including an additional plurality of data elements.

20. The method of claim 19, further comprising:
performing, for each of the additional plurality of data elements, an upcast operation to generate a plurality of upcast data elements.
